(19) United States
(12) Patent Application Publication
(10) Pub. No.: US 2024/0301587 A1
(43) Pub. Date: Sep. 12, 2024

(54) A PROCESS FOR PRODUCING POLYACRYLONITRILE-BASED FIBER HAVING CONTROLLED MORPHOLOGY

(71) Applicant: Cytec Industries, Inc., Princeton, NJ (US)

(72) Inventors: Jeremy Moskowitz, Mauldin, SC (US); Amy Tucker, Central, SC (US); Thomas Taylor, Greenville, SC (US); Varun Kumar, Greenville, SC (US); John Desmond Cook, Simpsonville, SC (US); Suzanne Crawford, Anderson, SC (US); Zachary Rodgers, Piedmont, SC (US)

(73) Assignee: Cytec Industries, Inc., Princeton, NJ (US)

(21) Appl. No.: 18/258,910

(22) PCT Filed: Dec. 8, 2021
(86) PCT No.: PCT/US2021/062342

§ 371 Date: Jun. 22, 2023

Related U.S. Application Data
(60) Provisional application No. 63/129,891, filed on Dec. 23, 2020.

(51) Int. Cl. D01F 1/10; C08K 7/06; D01D 1/02; D01D 5/06; D01F 6/18; D01F 9/22; D01F 11/06

(52) U.S. Cl. CPC D01F 1/10; C08K 7/06; D01D 1/02; D01D 5/06; D01F 6/18; D01F 9/225; D01F 11/06; D10B 2321/10; D10B 2401/20

(57) ABSTRACT

The present disclosure relates generally to a process for producing polymer fibers, typically polyacrylonitrile-based fibers, the morphology of which is controlled by the use of a polymer additive to form a polymer blend with polyacrylonitrile, which is then subjected to certain coagulation and washing conditions. The present disclosure also relates to carbon fibers produced by processing the polymer fibers made.

### CROSS REFERENCE TO RELATED APPLICATIONS

This present application claims priority to U.S. provisional application No. 63/129,891, filed Dec. 23, 2020, the entire contents of which is hereby incorporated by reference.

### FIELD OF THE INVENTION

The present disclosure relates generally to a process for producing polymer fibers, typically polyacrylonitrile-based fibers, the morphology of which is controlled by the use of a polymer additive to form a polymer blend with polyacrylonitrile, which is then subjected to certain coagulation and washing conditions. The present disclosure also relates to carbon fibers produced by processing the polymer fibers made.

### BACKGROUND

Carbon fibers have been used in a wide variety of applications because of their desirable properties, such as high strength and stiffness, high chemical resistance and low thermal expansion. For example, carbon fibers can be formed into a structural part that combines high strength and high stiffness, while having a weight that is significantly lighter than a metal component of equivalent properties. Increasingly, carbon fibers are being used as structural components in composite materials for aerospace and automotive applications, among others. In particular, composite materials have been developed wherein carbon fibers serve as a reinforcing material in a resin or ceramic matrix.

Over 90% of carbon fibers are derived from polyacrylonitrile (PAN)-based precursors. Generally, the process for PAN conversion to carbon fiber comprises solvent spinning (solution spinning), coagulation, oxidation, stabilization, and then carbonization.

During coagulation the non-solvent, typically water, flows into the polymer solution and the solvent (typically DMF, DMSO, etc.) flows into the bath creating the fiber filaments through counter-diffusion. In the first seconds of coagulation the fiber skin and core structure is primarily established and the successive baths are used to draw the filaments and remove residual solvent. While polymer chains can be aligned through stretching and add crystalline domains, it is difficult to manipulate fiber structure (or morphology), re-create skin-core structure, or establish new features after coagulation. Furthermore, there is rising interest in the carbon fiber industry for the introduction of porosity into fibers. Porous fibers may provide the benefit of allowing deeper penetration of the resin into the fiber and create a greater interphase region, thereby improving mechanical adhesion and translation properties in composite materials. Another potential benefit of porous fibers may be application in gas barrier technology in which diffusion and/or separation of gases is facilitated by the fiber. Porous fibers may provide lighter and more compact materials suitable for advanced membranes used in greenhouse gas separation, self-standing energy storage materials, and hydrogen production. Porous fibers also have lower density, which shows promise for producing lighter carbon fibers and may be an alternative pathway to hollow fiber.

However, porous fibers are generally thought to have poor mechanical performance due to the presence of voids and defects in the fiber. Creating a porous fiber is possible through purposeful selection of coagulation conditions that accelerate counter-diffusion of solvents and quench the fiber structure into a porous state. However, macrovoids formed in coagulation may interfere with stretching and drawability of the fiber. Also, macrovoids formed in nascent stages of fiber spinning may have amplified effects on the defects they create if formed too early.

Techniques for producing porous carbon fibers are known, such as physical or chemical activation, polymer blend carbonization, and templating using nanoparticles and block-copolymers. Polymer blend carbonization involves the blending of incompatible polymers that micro-phase separate into a) the matrix-forming, carbon source polymer and b) dispersed pore forming, sacrificial polymer. Such sacrificial polymers are then generally burned off by pyrolysis during the process of forming the porous carbon materials. Not only is the pore forming, sacrificial polymer unable to be recovered and recycled, removal of the said polymer during oxidation and carbonization leaves the carbon material or fiber susceptible to further damage, leading to degradation of mechanical properties.

Thus, there is an ongoing need for the development of processes for controlling the fiber structure (or morphology), such as introducing and manipulating porosity, in polymer fibers with mitigated impact on mechanical properties of the fiber made and, subsequently, carbon fiber made therefrom. Herein, a new strategy for controlling fiber morphology is described in which a polymer additive is used to form a polymer blend with polyacrylonitrile, which is then subjected to certain coagulation and washing conditions.

### SUMMARY OF THE INVENTION

Advantageously, it has been discovered that carbon fiber morphology can be controlled when a polymer additive is used to form a polymer blend with polyacrylonitrile. The polymer blend is then subjected to certain coagulation and washing conditions to remove the polymer additive in a controlled manner, introducing porosity into the resulting fibers having controlled morphology. Such fibers can then be transformed into carbon fiber. The polymer additive can be recovered and recycled and since removal of the polymer blend occurs before oxidation and carbonization, damage and degradation of mechanical properties are avoided.

In a first aspect, the present disclosure relates to a process for producing polyacrylonitrile-based fiber having controlled morphology, the process comprising:
a) forming a homogeneous solution comprising:
   a polyacrylonitrile-based polymer (polymer A),
   a polymer different from the polyacrylonitrile-based polymer (polymer B), and
   a first liquid comprising a solvent for polymer A,
      wherein polymer B is soluble in the first liquid;
b) co-precipitating polymer A and polymer B by contacting the homogeneous solution formed in step a) with a second liquid comprising a solvent for polymer A and a non-solvent for polymer A,
   wherein polymer B is insoluble in the second liquid, thereby forming the polyacrylonitrile-based material comprising polymer A and polymer B; and
c) selectively removing polymer B from the polyacrylonitrile-based material by contacting the polyacrylonitrile-based material with a third liquid comprising a non-solvent for polymer A,
   wherein polymer B is soluble in the third liquid,
      thereby producing the polyacrylonitrile-based fiber having controlled morphology.

In a second aspect, the present disclosure relates to polyacrylonitrile-based fiber produced by the process described herein.

In a third aspect, the present disclosure relates to a process for producing carbon fiber, the process comprising:
(i) producing a polyacrylonitrile-based fiber according to the process described herein;
(ii) oxidizing the polyacrylonitrile-based fiber produced in step (i) to form stabilized carbon fiber precursor fibers and then carbonizing the stabilized carbon fiber precursor fiber, thereby producing the carbon fiber.

In a fourth aspect, the present disclosure relates to carbon fiber produced by the process described herein.

In a fifth aspect, the present disclosure relates to a composite material comprising the carbon fiber produced according to the process described herein; and a matrix resin.

In a sixth aspect, the present disclosure relates to a composite article obtained by curing the composite material described herein.

### DETAILED DESCRIPTION

As used herein, the terms “a”, “an”, or “the” means “one or more” or “at least one” and may be used interchangeably, unless otherwise stated.

As used herein, the term “and/or” used in a phrase in the form of “A and/or B” means A alone, B alone, or A and B together.

As used herein, the term “comprises” includes “consists essentially of” and “consists of.” The term “comprising” includes “consisting essentially of” and “consisting of.” “Comprising”, which is synonymous with “including,” “containing,” or “characterized by,” is intended to be inclusive or open-ended and does not exclude additional, unrecited elements or steps. The transitional phrase “consisting essentially of” is inclusive of the specified materials or steps and those that do not materially affect the basic characteristic or function of the composition, process, method, or article of manufacture described. The transitional phrase “consisting of” excludes any element, step, or component not specified.

Unless defined otherwise, all technical and scientific terms used herein have the same meaning as is commonly understood by one of skill in the art to which this specification pertains.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

The process described herein employs a polymer blend comprising PAN and a polymer additive designed to control morphology, typically with judicious control of the coagulation and washing conditions. In particular, the polymer additive would be a polymer that has solubility in both a PAN non-solvent and solvent. The solubility in the solvent is necessary to form the homogeneous solution in the viscous spin “dope” prior to spinning. This is important since no blends can be formed by the polymer additive with PAN if they are not both soluble. The solubility in non-solvent would be unique and offer an opportunity to deliberately control the kinetics of counter-diffusion for the fibril formation. Further, if the polymer additive blended with PAN can be dissolved, for example, by altering conditions in the coagulation or wash baths, then it offers a chance to manipulate the structure beyond the nascent stages of coagulation.

Thus, the first aspect of the present disclosure relates to a process for producing polyacrylonitrile-based fiber having controlled morphology, the process comprising:
a) forming a homogeneous solution comprising:
   a polyacrylonitrile-based polymer (polymer A),
   a polymer different from the polyacrylonitrile-based polymer (polymer B), and
   a first liquid comprising a solvent for polymer A,
      wherein polymer B is soluble in the first liquid;
b) co-precipitating polymer A and polymer B by contacting the homogeneous solution formed in step a) with a second liquid comprising a solvent for polymer A and a non-solvent for polymer A,
   wherein polymer B is insoluble in the second liquid, thereby forming the polyacrylonitrile-based material comprising polymer A and polymer B; and
c) selectively removing polymer B from the polyacrylonitrile-based material by contacting the polyacrylonitrile-based material with a third liquid comprising a non-solvent for polymer A,
   wherein polymer B is soluble in the third liquid, thereby producing the polyacrylonitrile-based fiber having controlled morphology.

In step a) of the process, a homogeneous solution comprising a polyacrylonitrile-based polymer (polymer A), a polymer different from the polyacrylonitrile-based polymer (polymer B), and a first liquid comprising a solvent for polymer A, wherein polymer B is soluble in the first liquid, is formed.

The polyacrylonitrile-based polymer, polymer A, may be any polymer comprising repeating units derived from acrylonitrile. Suitable polyacrylonitrile-based polymer may be homopolymers consisting of repeating units derived from acrylonitrile or copolymers comprising repeating units derived from acrylonitrile and one or more comonomers. Such polymers may be obtained from commercially-available sources or prepared according to methods known to those of ordinary skill in the art. For example, polymer A can be made by any polymerization method, including, but not limited to, solution polymerization, dispersion polymerization, precipitation polymerization, suspension polymerization, emulsion polymerization, and variations thereof.

The polyacrylonitrile-based polymer comprises repeating units derived from acrylonitrile and at least one comonomer selected from the group consisting of vinyl-based acids, vinyl-based esters, vinyl amides, vinyl halides, ammonium salts of vinyl compounds, sodium salts of sulfonic acids, and mixtures thereof.

In an embodiment, the polyacrylonitrile-based polymer comprises repeating units derived from acrylonitrile and at least one comonomer selected from the group consisting of methacrylic acid (MAA), acrylic acid (AA), itaconic acid (ITA), methacrylate (MA), ethyl acrylate (EA), butyl acrylate (BA), methyl methacrylate (MMA), ethyl methacrylate (EMA), propyl methacrylate, butyl methacrylate, P-hydroxyethyl methacrylate, dimethylaminoethyl methacrylate, 2-ethylhexylacrylate, isopropyl acetate, vinyl acetate (VA), vinyl propionate, vinyl imidazole (VIM), acrylamide (AAm), diacetone acrylamide (DAAm), allyl chloride, vinyl bromide, vinyl chloride, vinylidene chloride, sodium vinyl sulfonate, sodium p-styrene sulfonate (SSS), sodium methallyl sulfonate (SMS), sodium-2-acrylamido-2-methyl propane sulfonate (SAMPS), and mixtures thereof.

The comonomer ratio (amount of one or more comonomers to amount of acrylonitrile) is not particularly limited. However, a suitable comonomer ratio is 0 to 20%, typically 1 to 5%, more typically 1 to 3%.

The molecular weight of the polyacrylonitrile-based polymers suitable for use according to the described process may be within the range of 60 to 500 kg/mole, typically 90 to 250 kg/mole, more typically 115 to 180 kg/mole.

The first liquid comprises a solvent for polymer A. Simultaneously, polymer B is soluble in the first liquid.

As used herein, the term “solvent” refers to any compound that, by itself, is capable of dissolving the respective polymer, typically completely, at the temperature at which the said solvent is used. On the other hand, the term “non-solvent” refers to any compound that, by itself, is not capable of dissolving the respective polymer at the temperature at which the non-solvent is used. It would be understood by a person of ordinary skill in the art that solvents and non-solvents, which are typically miscible, may be combined to form liquids in which the solubility of the respective polymers is different than in solvent alone or non-solvent alone.

As used herein, the term “soluble” when used to describe a material means that greater than or equal to 1% by weight, typically greater than or equal to 5% by weight, of the material relative to the weight of a particular solvent or liquid, can be dissolved in the said solvent or liquid. As used herein, the term “insoluble” when used to describe a material means that less than 1% by weight, typically less than 0.5% by weight, of the material, relative to the weight of a particular non-solvent or liquid, can be dissolved in the said non-solvent or liquid.

Suitable solvents for polymer A may be selected from the group consisting of dimethyl sulfoxide (DMSO), dimethyl formamide (DMF), dimethyl acetamide (DMAc), ethylene carbonate (EC), N-methyl-2-pyrrolidone (NMP), zinc chloride (ZnCl₂)/water, sodium thiocyanate (NaSCN)/water, and mixtures thereof, typically selected from the group consisting of dimethyl sulfoxide (DMSO), dimethyl formamide (DMF), dimethyl acetamide (DMAc), ethylene carbonate (EC), N-methyl-2-pyrrolidone (NMP).

In step a), the temperature of the first liquid is kept above room temperature, i.e., greater than 25° C. In an embodiment, the temperature of the first liquid is about 40° C. to about 85° C.

The homogeneous solution produced is typically free of gels and/or agglomerated polymer. The presence of gels and/or agglomerated polymer may be determined using any method known to those of ordinary skill in the art. For example, a Hegman gauge may be used to determine the presence of gels and/or agglomerated polymer. The homogeneous solutions made are generally stable and do not exhibit gel formation over time.

The homogeneous solution may have a polymer concentration of at least 10 wt %, typically from about 16 wt % to about 28 wt % by weight, more typically from about 19 wt % to about 24 wt %, based on total weight of the solution.

Step b) is the co-precipitation of polymer A and polymer B by contacting the homogeneous solution formed in step a) with a second liquid comprising a solvent for polymer A and a non-solvent for polymer A, wherein polymer B is insoluble in the second liquid, thereby forming a polyacrylonitrile-based material comprising polymer A and polymer B.

The second liquid comprises a solvent for polymer A and a non-solvent for polymer A, and polymer B is insoluble in the second liquid. As result, when the homogeneous solution formed in step a) is contacted with the second liquid, polymer A and polymer B is co-precipitated in the form a polyacrylonitrile-based material, which is typically in the form a solid, such as a film, discrete particles, fibers, or the like.

The second liquid used in the process is a mixture of solvent and non-solvent for polymer A. Suitable solvents include the solvents described herein. In an embodiment, dimethyl sulfoxide, dimethyl formamide, dimethyl acetamide, or mixtures thereof, is used as solvent. In another embodiment, dimethyl sulfoxide is used as solvent.

The non-solvent for polymer A may be any compound known to those of ordinary skill the art that does not dissolve polymer A at the temperature used. Exemplary non-solvents for polymer A include water and C₁-C₆ alkanols, such as methanol, ethanol, n-propanol, isopropanol, and the like. In an embodiment, the non-solvent for polymer A is water.

The ratio of solvent and non-solvent, and temperature are not particularly limited and may be adjusted according to known methods to achieve the desired solidification rate. However, the second liquid suitably comprises less than or equal to 85 wt % of the solvent for polymer A and greater than or equal to 15 wt % of the non-solvent for polymer A, relative to the total weight of the second liquid.

In another embodiment, the second liquid comprises 40 wt % to 85 wt % of one or more solvents, the balance being non-solvent. In an embodiment, the second liquid comprises 40 wt % to 70 wt % of one or more solvents, the balance being non-solvent. In yet another embodiment, the second liquid comprises 50 wt % to 85 wt % of one or more solvents, the balance being non-solvent.

Typically, the temperature of the second liquid is from 0° C. to 80° C. In an embodiment, the temperature of the second liquid is from 30° C. to 80° C. In another embodiment, the temperature of the second liquid is from 0° C. to 20° C.

In an embodiment, step b) comprises spinning the homogeneous solution formed in step a) in or into a coagulation bath containing the second liquid comprising a solvent for polymer A and a non-solvent for polymer A to form the polyacrylonitrile-based material as one or more fibers.

In this embodiment, the homogeneous solution is spun in or into a coagulation bath.

The homogeneous solution (“spin dope”) may be subjected to conventional wet spinning and/or air-gap spinning after removing air bubbles by vacuum. In wet spinning, the dope is filtered and extruded through holes of a spinneret (typically made of metal) into a liquid coagulation bath for the polymer to form filaments. The spinneret holes determine the desired filament count of the fiber (e.g., 3,000 holes for 3K carbon fiber). In air-gap spinning, a vertical air gap of 1 to 50 mm, typically 2 to 10 mm, is provided between the spinneret and the coagulating bath. In an embodiment, the polymer solution is filtered and extruded in the air from the spinneret and then extruded filaments are coagulated in a coagulating bath.

The solvent for polymer A in the first liquid and the solvent for polymer A in the second liquid may be the same or different and are each selected from the group consisting of dimethyl sulfoxide (DMSO), dimethyl formamide (DMF), dimethyl acetamide (DMAc), ethylene carbonate (EC), N-methyl-2-pyrrolidone (NMP), zinc chloride (ZnCl₂)/water, sodium thiocyanate (NaSCN)/water, and mixtures thereof, typically selected from the group consisting of dimethyl sulfoxide (DMSO), dimethyl formamide (DMF), dimethyl acetamide (DMAc), ethylene carbonate (EC), N-methyl-2-pyrrolidone (NMP).

In an embodiment, the solvent for polymer A in the first liquid and the solvent for polymer A in the second liquid are identical.

In step c), polymer B is selectively removing from the polyacrylonitrile-based material by contacting the polyacrylonitrile-based material with a third liquid comprising a non-solvent for polymer A, in which polymer B is soluble.

The third liquid comprises a non-solvent for polymer A, but is such that polymer B is soluble in the third liquid. Thus, in the step c), polymer B may be removed in a selective manner from the PAN polymer fiber, producing the polyacrylonitrile-based fiber having controlled morphology.

The temperature of the third liquid is from 0 to 100° C., typically 0 to 30° C., more typically 10 to 25° C.

The non-solvent for polymer A in the second liquid and the non-solvent for polymer A in the third liquid may be the same or different. In an embodiment, the non-solvent for polymer A in the second liquid and the non-solvent for polymer A in the third liquid are identical.

In an embodiment, the non-solvent for polymer A in the second liquid and the non-solvent for polymer A in the third liquid are each water.

In an embodiment, the first liquid consists of the solvent for polymer A.

In another embodiment, the second liquid consists of the solvent for polymer A and the non-solvent for polymer A.

In yet another embodiment, the third liquid consists of the non-solvent for polymer A.

In an embodiment, step c) comprises drawing the one or more fibers through one or more draw and wash baths, wherein at least one bath contains the third liquid comprising a non-solvent for polymer A.

The drawing of the coagulated polymer fiber is conducted by conveying the said fibers through one or more draw and wash baths, for example, by rollers. The coagulated polymer fibers are conveyed through one or more wash baths to remove any excess solvent followed by stretching in hot water baths (e.g., 40° C. to 100° C.) to impart molecular orientation to the filaments as the first step of controlling fiber diameter. The resultant drawn polymer fiber are substantially free of solvent.

Thus, in an embodiment, step c) comprises drawing the one or more fibers through a plurality of draw and wash baths, wherein the first bath contains the third liquid comprising the non-solvent for polymer and wherein the temperature of the first bath is 0 to 30° C., typically 10 to 25° C. The first bath refers to the bath immediately following the one used in step b). Baths following the first bath may have a temperature of up to 100° C.

The polymer additive, i.e., polymer B, that is combined with polymer A to form the homogeneous solution in the process described herein is a polymer that is different from polymer A. Suitable polymers for use as polymer B are polymers that a soluble in the first liquid, insoluble in the second liquid, and soluble in the third liquid at the temperatures used, and may be homopolymers or copolymers. One suitable polymer is a polymer that comprises one or more repeating units derived from at least one monomer according to formula (I):

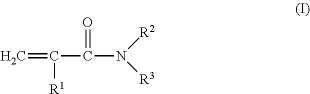

wherein:
R¹ is H or methyl,
R² and R³ are each independently H or alkyl, typically H or (C₁-C₆)alkyl.

As used herein, the terminology “Cx-Cy” or “(Cx-Cy)” in reference to an organic group, wherein x and y are each integers, means that the group may contain from x carbon atoms to y carbon atoms per group.

As used herein, the term “alkyl” means a monovalent straight or branched saturated hydrocarbon radical, such as, for example, methyl, ethyl, n-propyl, isopropyl, n-butyl, isobutyl, tert-butyl, pentyl, hexyl, and so on.

As used herein, the term “derived from” means that the repeating units in the polymer are formed by polymerization of the monomers described herein according to methods well-known to those of ordinary skill. Optionally, the polymer may have undergone subsequent chemical modification. For example, polymers produced by polymerization of acyl group-containing monomers may be hydrolyzed to form a polymer bearing hydroxyl groups.

In an embodiment, polymer B is a homopolymer derived from a monomer according to formula (I).

In another embodiment, polymer B is poly(N-isopropylacrylamide).

In an embodiment, polymer B is a copolymer comprising monomeric units derived from a monomer according to formula (I), more typically wherein greater than or equal to about 50 percent by weight (“wt %”) of the repeating units of the polymer are derived from a monomer according to formula (I).

Another suitable polymer is a polymer that comprises one or more repeating units derived from at least one monomer according to formula (II):

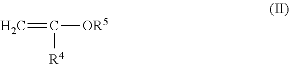

wherein:
R⁴ is H or methyl,
R⁵ is H, alkyl, or acyl, typically H or acyl.

As used herein, the term “acyl” refers to a substituent characterized by the formula —(C═O)—R, in which R is an alkyl group.

In an embodiment, polymer B is a homopolymer derived from a monomer according to formula (II).

In another embodiment, polymer B is polyvinyl alcohol.

In another embodiment, polymer B is a copolymer comprising monomeric units derived from a monomer according to formula (II), more typically wherein greater than or equal to about 50 percent by weight (“wt %”) of the repeating units of the polymer are derived from a monomer according to formula (II).

In step a), the amount of polymer B combined with polymer A to form the homogeneous solution is not particularly limited. However, suitable results are obtained when homogeneous solution comprises less than or equal to 50 wt %, typically less than or equal to 20 wt %, more typically less than or equal to 10 wt %, of polymer B, relative to the total weight of the homogeneous solution.

The process may further comprise a step d) of drying the drawn polymer fibers that are substantially free of solvent, for example, on drying rolls. The drying rolls can be composed of a plurality of rotatable rolls arranged in series and in serpentine configuration over which the filaments pass sequentially from roll to roll and under sufficient tension to provide filaments stretch or relaxation on the rolls. At least some of the rolls are heated by pressurized steam, which is circulated internally or through the rolls, or electrical heating elements inside of the rolls. Finishing oil can be applied onto the stretched fibers prior to drying in order to prevent the filaments from sticking to each other in downstream processes.

The process of the present disclosure may be conducted continuously or in a batch manner. As used herein, a process “conducted continuously” refers to a process in which the fiber is conveyed through one or more processing steps a single work unit at a time without any breaks in time, substance, or sequence. This is in contrast to a batch process, which would be understood as being a process that comprises a sequence of one or more steps that are performed in a defined order and in which a finite quantity of material is treated or produced at the end of the sequence, which must be repeated in order to treat or produce another batch of material. In an embodiment, the process is conducted continuously.

Advantageously, the polymer additive, polymer B, can be recovered and recycled. The ability to recover polymer B from the process provides an advantage over “sacrificial polymers” that are volatized during pyrolysis and lost during the downstream carbon fiber forming process. Thus, in an embodiment, the process further comprises a step e) of recovering at least partially polymer B. Any separation method known to those of ordinary skill in the art may be used to recover polymer B from any of the steps in the process. For example, vacuum distillation, thin film evaporation, or the like, may be used to recover polymer B from any of the liquids described herein.

In a second aspect, the present disclosure relates to the polyacrylonitrile-based fiber produced by the process described herein. The polyacrylonitrile-based fiber produced by the process described herein may be employed as a precursor fiber, so-called white fiber, for the production of carbon fiber.

Thus, in the third aspect, the present disclosure relates to a process for producing carbon fiber, the process comprising:
(i) producing a polyacrylonitrile-based fiber according to the process described herein;
(ii) oxidizing the polyacrylonitrile-based fiber produced in step (i) to form stabilized carbon fiber precursor fibers and then carbonizing the stabilized carbon fiber precursor fiber, thereby producing the carbon fiber.

After producing a polyacrylonitrile-based fiber according to the process described herein, the polyacrylonitrile-based fiber may be oxidized to form stabilized carbon fiber precursor fibers and, subsequently, the stabilized carbon fiber precursor fiber are carbonized to produce carbon fibers.

During the oxidation stage, the polymer fiber are fed under tension through one or more specialized ovens, each having a temperature from 150 to 300° C., typically from 200 to 280° C., more typically from 220 to 270° C., in which heated air is fed into each of the ovens.

The oxidation process combines oxygen molecules from the air with the fiber and causes the polymer chains to start crosslinking, thereby increasing the fiber density to 1.30 g/cm³ to 1.45 g/cm³. Such oxidized PAN fiber has an infusible ladder aromatic molecular structure and it is ready for carbonization treatment.

Carbonization results in the crystallization of carbon molecules and consequently produces a finished carbon fiber that has more than 90 percent carbon content. Carbonization of the oxidized, or stabilized, carbon fiber precursor fibers occurs in an inert (oxygen-free) atmosphere, typically nitrogen atmosphere, inside one or more specially designed furnaces. The oxidized carbon fiber precursor fibers are passed through one or more ovens each heated to a temperature of from 300° C. to 1650° C., typically from 1100° C. to 1450° C.

Adhesion between the matrix resin and carbon fiber is an important criterion in a carbon fiber-reinforced polymer composite. As such, during the manufacture of carbon fiber, surface treatment may be performed after oxidation and carbonization to enhance this adhesion.

Surface treatment may include pulling the carbonized fiber through an electrolytic bath containing an electrolyte, such as ammonium bicarbonate or sodium hypochlorite. The chemicals of the electrolytic bath etch or roughen the surface of the fiber, thereby increasing the surface area available for interfacial fiber/matrix bonding and adding reactive chemical groups.

Next, the carbon fiber may be subjected to sizing, where a size coating, e.g. epoxy-based coating, is applied onto the fiber. Sizing may be carried out by passing the fiber through a size bath containing a liquid coating material. Sizing protects the carbon fiber during handling and processing into intermediate forms, such as dry fabric and prepreg. Sizing also holds filaments together in individual tows to reduce fuzz, improve processability and increase interfacial shear strength between the fiber and the matrix resin.

Following sizing, the coated carbon fiber is dried and then wound onto a bobbin.

A person of ordinary skill in the art would understand that the processing conditions (including composition of the spin solution and coagulation bath, the amount of total baths, stretches, temperatures, and filament speeds) are correlated to provide filaments of a desired structure and denier.

In a fourth aspect, the present disclosure relates to the carbon fiber produced by the process described herein.

Carbon fibers produced according to the process described herein may be characterized by mechanical properties, such as tensile strength and tensile modulus per the ASTM D4018 test method.

The carbon fibers produced generally have a tensile strength of from 300 to 1000 ksi, typicaly 400 to 600 ksi.

The carbon fibers produced generally have a tensile modulus of from 30 to 50 msi, typically 35 to 40 msi.

The carbon fibers produced may be characterized by their density. Generally, the carbon fibers formed according to the process described herein have lower density than conventional carbon fibers. Advantageously, the present disclosure provides for low density, lightweight carbon fibers. The carbon fibers produced according to the present disclosure may have a density of less than or equal to 1.80 g/cm³, typically less than or equal to 1.79 g/cm³, typically less than or equal to 1.78 g/cm³. In an embodiment, the density is from 1.50 to 1.77 g/cm³. In another embodiment, the density is from 1.70 to 1.77 g/cm³ or from 1.74 to 1.79 g/cm³.

The carbon fiber produced herein are suitable for use in the production of composite materials. Thus, in a fifth aspect, the present disclosure relates to a composite material comprising the carbon fiber produced according to the process described herein and a matrix resin.

Composite materials may be made by molding a preform comprising the carbon fiber produced according to the process described herein and infusing the preform with a thermosetting resin in a number of liquid-molding processes. Liquid-molding processes that may be used include, without limitation, vacuum-assisted resin transfer molding (VARTM), in which resin is infused into the preform using a vacuum-generated pressure differential. Another method is resin transfer molding (RTM), wherein resin is infused under pressure into the preform in a closed mold. A third method is resin film infusion (RFI), wherein a semi-solid resin is placed underneath or on top of the preform, appropriate tooling is located on the part, the part is bagged and then placed in an autoclave to melt and infuse the resin into the preform.

The matrix resin for impregnating or infusing the preforms described herein is a curable resin. “Curing” or “cure” in the present disclosure refers to the hardening of a polymeric material by the chemical cross-linking of the polymer chains. The term “curable” in reference to a composition means that the composition is capable of being subjected to conditions which will render the composition to a hardened or thermoset state. The matrix resin typically is a hardenable or thermoset resin containing one or more uncured thermoset resins or thermoplastic resin. Suitable thermoset resins include, but are not limited to, epoxy resins, oxetanes, imides (such as polyimide or bismaleimide), vinyl ester resins, cyanate ester resins, isocyanate-modified epoxy resins, phenolic resins, furanic resins, benzoxazines, formaldehyde condensate resins (such as with urea, melamine or phenol), polyesters, acrylics, hybrids, blends and combinations thereof. Suitable thermoplastic resins include, but are not limited to polyolefins, fluoropolymers, perfluorosulfonic acids, poly amid-imides, polyamides, polyesters, polyketones, polyphenylene sulfides, polyvinylidene chlorides, sulfone polymers, hybrids, blends and combinations thereof.

Suitable epoxy resins include glycidyl derivatives of aromatic diamine, aromatic mono primary amines, aminophenols, polyhydric phenols, polyhydric alcohols, polycarboxylic acids and non-glycidyl resins produced by peroxidation of olefinic double bonds. Examples of suitable epoxy resins include polyglycidyl ethers of the bisphenols, such as bisphenol A, bisphenol F, bisphenol S, bisphenol K and bisphenol Z; polyglycidyl ethers of cresol and phenol-based novolacs, glycidyl ethers of phenol-aldelyde adducts, glycidyl ethers of aliphatic dials, diglycidyl ether, diethylene glycol diglycidyl ether, aromatic epoxy resins, aliphatic polyglycidylethers, epoxidised olefins, brominated resins, aromatic glycidyl amines, heterocyclic glycidyl imidines and amides, glycidyl ethers, fluorinated epoxy resins, or combinations thereof.

Specific examples are tetraglycidyl derivatives of 4,4′-diaminodiphenylmethane (TGDDM), resorcinol diglycidyl ether, triglycidyl-p-aminophenol, triglycidyl-m-aminophenol, bromobisphenol F diglycidyl ether, tetraglycidyl derivatives of diaminodiphenylmethane, trihydroxyphenyl methane triglycidyl ether, polyglycidylether of phenol-formaldehyde novolac, polyglycidylether of o-cresol novolac or tetraglycidyl ether of tetraphenylethane.

Suitable oxetane compounds, which are compounds that comprise at least one oxetano group per molecule, include compounds such as, for example, 3-ethyl-3[[(3-ethyloxetane-3-yl)methoxy]methyl]oxetane, oxetane-3-methanol, 3,3-bis-(hydroxymethyl) oxetane, 3-butyl-3-methyl oxetane, 3-methyl-3-oxetanemethanol, 3,3-dipropyl oxetane, and 3-ethyl-3-(hydroxymethyl) oxetane.

The curable matrix resin may optionally comprise one or more additives such as curing agents, curing catalysts, co-monomers, rheology control agents, tackifiers, inorganic or organic fillers, thermoplastic and/or elastomeric polymers as toughening agents, stabilizers, inhibitors, pigments, dyes, flame retardants, reactive diluents, UV absorbers and other additives well known to those of ordinary skill in the art for modifying the properties of the matrix resin before and/or after curing.

Examples of suitable curing agents include, but are not limited to, aromatic, aliphatic and alicyclic amines, or guanidine derivatives. Suitable aromatic amines include 4,4′-diaminodiphenyl sulphone (4,4′-DDS), and 3,3′ diaminodiphenyl sulphone (3,3′-DDS), 1,3-diaminobenzene, 1,4-diaminobenzene, 4,4′-diammodiphenylmethane, benzenediamine(BDA); Suitable aliphatic amines include ethylenediamine (EDA), 4,4′-methylenebis(2,6-diethylaniline) (M-DEA), m-xylenediamine (mXDA), diethylenetriamine (DETA), triethylenetetramine (TETA), trioxatridecanediamine (TTDA), polyoxypropylene diamine, and further homologues, alicyclic amines such as diaminocyclohexane (DACH), isophoronediamine (IPDA), 4,4′ diamino dicyclohexyl methane (PACM), bisaminopropylpiperazine (BAPP), N-aminoethylpiperazine (N-AEP); Other suitable curing agents also include anhydrides, typically polycarboxylic anhydrides, such as nadic anhydride, methylnadic anhydride, phthalic anhydride, tetrahydrophthalic anhydride, hexahydrophthalic anhydride, methyltetrahydrophthalic anhydride, methylhexahydrophthalic anhydride, endomethylene-tetrahydrophtalic anhydride, pyromellitic dianhydride, chloroendic anliydride and trimellitic anhydride.

Still other curing agents are Lewis acid:Lewis base complexes. Suitable Lewis acid:Lewis base complexes include, for example, complexes of: BCl₃:amine complexes, BF₃:amine complexes, such as BF₃:monoethylamine, BF₃:propylamine, BF₃:isopropyl amine, BF₃:benzyl amine, BF₃:chlorobenzyl amine, BF₃:trimethylamine, BF₃:pyridine, BF₃:THF, AlCl₃:THF, AICls:acetonitrile, and ZnCl₂:THF.

Additional curing agents are polyamides, polyamines, amidoamines, polyamidoamines, polycycloaliphatic, polyetheramide, imidazoles, dicyandiamide, substituted ureas and urones, hydrazines and silicones.

Urea based curing agents are the range of materials available under the commercial name DYHARD (marketed by Alzchem), and urea derivatives, such as the ones commercially available as UR200, UR300, UR400, UR600 and UR700. Urone accelerators include, for example, 4,4-methylene diphenylene bis(N,N-dimethyl urea) (available from Onmicure as U52 M).

When present, the total amount of curing agent is in the range of 1 wt % to 60 wt % of the resin composition. Typically, the curing agent is present in the range of 15 wt % to 50 wt %, more typically in the range of 20 wt % to 30 wt %.

Suitable toughening agents may include, but are not limited to, homopolymers or copolymers either alone or in combination of polyamides, copolyamides, polyimides, aramids, polyketones, polyetherimides (PEI), polyetherketones (PEK), polyetherketoneketone (PEKK), polyetheretherketones (PEEK), polyethersulfones (PES), polyetherethersulfones (PEES), polyesters, polyurethanes, polysulphones, polysulphides, polyphenylene oxide (PPO) and modified PPO, poly(ethylene oxide) (PEO) and polypropylene oxide, polystyrenes, polybutadienes, polyacrylates, polystyrene, polymethacrylates, polyacrylics, polyphenylsulfone, high performance hydrocarbon polymers, liquid crystal polymers, elastomers, segmented elastomers and core-shell particles.

Toughening particles or agents, when present, may be present in the range 0.1 wt % to 30 wt % of the resin composition. In an embodiment, the toughening particles or agents may be present in the range 10 wt % to 25 wt %. In another embodiment, the toughening particles or agents may be present in the range from 0.1 to 10 wt %. Suitable toughening particles or agents include, for example, Virantage VW10200 FRP, VW10300 FP and VW10700 FRP from Solvay, BASF Ultrason E2020 and Sumikaexcel 5003P from Sumitomo Chemicals.

The toughening particles or agents may be in the form of particles having a diameter larger than 20 microns to prevent them from being incorporated into the fiber layers. The size of the toughening particles or agents may be selected such that they are not filtered by the fiber reinforcement. Optionally, the composition may also comprise inorganic ceramic particles, microspheres, micro-balloons and clays.

The resin composition may also contain conductive particles such as the ones described in PCT International Publications WO 2013/141916, WO 2015/130368 and WO 2016/048885.

The mold for resin infusion may be a two-component, closed mold or a vacuum bag sealed, single-sided mold. Following infusion of the matrix resin in the mold, the mold is heated to cure the resin.

During heating, the resin reacts with itself to form crosslinks in the matrix of the composite material. After an initial period of heating, the resin gels. Upon gelling, the resin no longer flows, but rather behaves as a solid. After gel, the temperature or cure may be ramped up to a final temperature to complete the cure. The final cure temperature depends on the nature and properties of the thermosetting resin chosen. Thus, in a suitable method, the composite material is heated to a first temperature suitable to gel the matrix resin, after which the temperature is ramped up to a second temperature and held for a time at the second temperature to complete the cure. Thereby, a composite article is obtained.

The process according to the present disclosure and carbon fibers produced therefrom are further illustrated by the following non-limiting examples.

### EXAMPLES

### Example 1. PAN/pNIPAM Film

A polyacrylonitrile-based polymer having repeating units derived from methacrylic acid (MAA) was used. Poly(N-isopropylacrylamide (pNIPAM; available from Sigma Aldrich with a number average molecular weight of about 40,000 kDa) was used a polymer additive. Blends of the two polymers were prepared using a Thinky AR-100 centrifugal mixer (2000 rpm) at sample sizes of about 6 grams using either 1 or 10 wt. % pNIPAM with respect to the PAN-based polymer concentration (˜15 wt. %) in DMSO. Polymer films were prepared by spreading the solution on a glass plate into a thin film and allowing to air dry. Films were then extracted in one of the following ways:

| Method | Description |
|---|---|
| 1 | Methanol rinse (spray methanol over the sample) |
| 2 | Accelerated solvent extraction (ASE) extraction using |
| | methanol |
| 3 | Cold water rinse (spray cold water over the sample) |
| 4 | Cold water extraction (using room temperature water for |
| | solvent in ASE extraction) |
| 5 | Hot water extraction (using hot water for solvent in ASE |
| | extraction) |
| 6 | Water soak (allowing sample to soak in water bath 2-3 hours) |
| 7 | DMSO/water rinse (using a 50/50 mixture co-solvent to |
| | spray over the sample) |

FTIR was used to determine the presence of pNIPAM by following two peaks c.a. 1540 and 1640 cm⁻¹, pertaining to C—N(stretch.) and C═O (stretch) of the amide group, respectively. Because the peak c.a. 1640 cm⁻¹ overlaps with the polymer baseline peak pertaining to the carboxylic acid functionality, the peak c.a. 1540 cm⁻¹ is used as a quantitative measure of the presence of pNIPAM in the polymer.

Method 2 showed the greatest reduction of pNIPAM compared to the other extraction methods. Method 6 was the second most effective extraction method. The rinse extractions (methods 1, 3, and 7) were the least effective and retained the most pNIPAM. Of the methods that utilize water, method 6 was determined to be most efficient at removing pNIPAM.

To further investigate the effect of temperature, water soaks were performed either at 10 or 50° C. for 2-3 hours for both 1 wt. % pNIPAM and 10 wt. % pNIPAM films (wt. % is wrt to PAN-based polymer). The cold water wash exhibited a smaller peak c.a. 1540 cm⁻¹ at both loading levels.

Scanning electron microscopy (SEM) was used to examine the physical features of the film before and after extraction. Before extraction, the film looks smooth and at higher magnifications the film looks grainy and at 50,000× magnification the film appears to be a spongy network. After extraction, the lower magnification images have many surface features that are absent in the control film. The surface is riddled with small indentations or little holes left behind from the pNIPAM extraction from the PAN-based polymer. At higher magnification the surface features appears to be submicron cavities.

### Example 2. PAN/pNIPAM White Fiber

The polymer blends made using the PAN-based polymer and polymer additive used in Example 1. The PAN-based polymer and pNIPAM were dissolved using a 15-gallon Myers Mixer (3.16 kg PAN-based polymer and 30 g of pNIPAM in 14.49 kg of DMSO) with the disperser at 500 rpm and the sweeper at 60 rpm. The temperature was ramped to 80° C. and run for 2 hours before allowing cooling to 45° C. The polymer solutions (“dope”) were then spun into a coagulation bath (65% DMSO). The coagulation bath varied between 40 and 50° C. and the 1st draw bath was either 60° C. or chilled to below 10° C. with ice. As control, the same spinning process was conducted on the PAN-based polymer without pNIPAM.

All of the filaments imaged by standard sample preparation techniques appear normal and show no signs of deviation from the control process. The optical images demonstrated no macrovoids. Thus, introduction of 1 wt. % pNIPAM did not significantly alter the preferred coagulation window from the baseline process.

However, by SEM, the fiber structure showed apparent differences at the submicron scale. For example, a sample taken from coagulation bath showed a filament with a smooth skin and an internal core structure that is riddled with porosity across the entire cross section. Surprisingly, the skin surface remained intact with no indications of surface defects. The core structure appeared more open and spongy-like as compared to standard coagulation samples and, in particular, the network contains many small cavities as observed previously in the film structure. It was unexpected that the coagulation sample would show such pronounced porosity as the concentration of the bath was 65 wt. % DMSO (outside the solubility of pNIPAM), but it is surmised that the pNIPAM precipitates at a different rate from the PAN-based polymer and phase separates upon coagulation.

The coagulated filaments were drawn and it was found that the porous structure remained intact. The sponge-like core densified and the surface skin roughened as the fiber was drawn. The pore size decreased, but the core still retained many small indents in the structure, which were on the order of 100 nm in size. It was found that the pNIPAM concentration in the fiber was greater in the coagulation bath as compared to the wash bath and decreased following the washing step, indicating that pNIPAM was removed from the fiber during washing.

Another difference that was found for the pNIPAM-blended fibers as compared to those for the control process lies in the swelling behavior. The degree of swelling for the pNIPAM-blended fibers and control fibers were determined according to the following procedure. Samples were taken and first centrifuged at 3000 rpm for 15 minutes to remove any adhered liquid from the filament surface. The collected samples were then submerged in a glass beaker/flask containing deionized water, and “washed” for a minimum of 15 minutes. This washing step was then repeated twice more with fresh deionized water to ensure the samples were fully coagulated and solvent has been removed. Once the final wash was completed, the sample was centrifuged again at 3,000 rpm for 15 minutes and weighed to obtain after-wash weight, or Wₐ. Samples were then placed in an air circulating oven at 110° C. for 3 hours. Following drying, samples were removed from the oven and placed in a desiccator for a minimum of ten minutes. The dried and desiccated samples were re-weighed and the final weight recorded as W_{f}. The degree of swelling was then calculated using the following relation:

$$Degree of Swelling ( \% ) = ( {W}_{a} - {W}_{f} ) \times ( 100 / {W}_{f} )$$

This method correlates the fiber porosity to the liquid uptake.

The swelling of the pNIPAM-blended sample is much lower (183%) vs. the control sample (192%) for the coagulated sample and the 1st draw sample as well (163% vs 181%). The differences suggest that pNIPAM may influence the kinetics of counter-diffusion for solvent in and out of the fiber.

Interestingly, the mechanical properties of the pNIPAM-blended fibers did not appear to be impacted by coagulation bath and 1st draw bath conditions even though differences in structure, i.e. presence of porosity, and swelling behavior were noted. The tenacity, elongation, and Young's modulus are all within range of the measurement and process error for these runs.

### Example 3. Carbon Fiber Made from PAN/pNIPAM White Fiber

The PAN/pNIPAM white fiber made according to the procedure described in Example 2 was oxidized and carbonized to form carbon fiber. White fiber made from PAN-based polymer that did not contain pNIPAM was oxidized and carbonized to form carbon fiber. It was observed that the addition of pNIPAM did not significantly impact the mechanical properties. For six carbonization runs to form control fiber, the mean tensile strength was 482+/−32 ksi and the mean tensile strength was 39.1+/−0.4 Msi, while the carbon fiber made from the PAN/pNIPAM white fiber exhibited tensile strengths above 500 ksi and moduli above 38.3 Msi. This result is indicative that the presence of 1% pNIPAM did not hinder mechanical load bearing capability of the carbon fibers made from the PAN/pNIPAM blend. The density of the said carbon fibers was lower than typical at 1.74 to 1.79 g/cm³.

Strand fractography of the inventive carbon fibers interestingly showed very fine pores in the cross section of the fibers. The pores are all below 100 nanometers in size and mostly concentrated near the skin surface of the fiber. This demonstrates that the porosity created in spinning is retained through carbonization.

### Example 4. PAN/PVOH White Fiber

Spin dope was made according to the procedure described in Example 2, except that pNIPAM was replaced with polyvinyl alcohol (PVOH; available from Sigma Aldrich). The final spin dope contained ˜17.5 wt % solids (PAN-based polymer+pNIPAM) and ˜5 wt. % PVOH (relative to PAN-based polymer) The zero-shear viscosity at 45° C. was ˜56 Pa*sec.

The spin dope was spun to form PAN/PVOH white fiber as in Example 2, with the coagulation bath set at 50° C.

Samples of the fiber were taken after coagulation and after the first draw bath. The swelling of the sample taken after coagulation was 241%, which was much higher than typical for fiber made from the same PAN-based polymer alone, which is generally ˜190-200%). The swelling of the sample after 1st draw was 174%, which was also much higher than typical for fiber made from the same PAN-based polymer alone, which is generally ˜120-140%). As with pNIPAM, the differences suggest that PVOH may influence the kinetics of counter-diffusion for solvent in and out of the fiber. Further, fiber samples extracted after the washing steps show a fiber with even greater pore concentration and cavities throughout the core of the fiber as compared to Example 2 due to the higher concentration of PVOH in relation to the PAN-based polymer. This importantly indicates that pore density and pore volume can be controlled by the polymer blend concentration polymer blend characteristics.

### Example 5. Carbon Fiber Made from PAN/PVOH White Fiber

The PAN/PVOH white fiber made according to the procedure described in Example 4 was oxidized and carbonized to successfully form carbon fiber.

The tensile strength was 340+/−12 ksi and tensile modulus was 31+/−2.5 Msi (per ASTM method). The density of the carbon fibers made from PAN/PVOH was also lower than typical at 1.70 to 1.77 g/cm³.

It would be apparent to a person of ordinary skill in that art that the conditions for conducting the inventive processes described herein may be optimized based on the intended application and circumstances without departing from the spirit of the present disclosure.

1. A process for producing polyacrylonitrile-based fiber having controlled morphology, the process comprising:
a) forming a homogeneous solution comprising:
a polyacrylonitrile-based polymer (polymer A),
a polymer different from the polyacrylonitrile-based polymer (polymer B), and
a first liquid comprising a solvent for polymer A,
wherein polymer B is soluble in the first liquid;
b) co-precipitating polymer A and polymer B by contacting the homogeneous solution formed in step a) with a second liquid comprising a solvent for polymer A and a non-solvent for polymer A,
wherein polymer B is insoluble in the second liquid, thereby forming the polyacrylonitrile-based material comprising polymer A and polymer B; and
c) selectively removing polymer B from the polyacrylonitrile-based material by contacting the polyacrylonitrile-based material with a third liquid comprising a non-solvent for polymer A,
wherein polymer B is soluble in the third liquid,
thereby producing the polyacrylonitrile-based fiber having controlled morphology.

2. The process according to claim 1, wherein the solvent for polymer A in the first liquid and the solvent for polymer A in the second liquid are identical.

3. The process according to claim 1, wherein the solvent for polymer A in the first liquid and the solvent for polymer A in the second liquid are each selected from the group consisting of dimethyl sulfoxide (DMSO), dimethyl formamide (DMF), dimethyl acetamide (DMAc), ethylene carbonate (EC), N-methyl-2-pyrrolidone (NMP), zinc chloride (ZnCl₂)/water, sodium thiocyanate (NaSCN)/water, and mixtures thereof.

4. The process according to claim 1, wherein the non-solvent for polymer A in the second liquid and the non-solvent for polymer A in the third liquid are identical.

5. The process according to claim 1, wherein the non-solvent for polymer A in the second liquid and the non-solvent for polymer A in the third liquid are each water.

6. The process according to claim 1, wherein the first liquid consists of the solvent for polymer A.

7. The process according to claim 1, wherein the second liquid consists of the solvent for polymer A and the non-solvent for polymer A.

8. The process according to claim 1, wherein the third liquid consists of the non-solvent for polymer A.

9. The process according to claim 1, wherein polymer A comprises repeating units derived from acrylonitrile and at least one comonomer selected from the group consisting of methacrylic acid (MAA), acrylic acid (AA), itaconic acid (ITA), methacrylate (MA), ethyl acrylate (EA), butyl acrylate (BA), methyl methacrylate (MMA), ethyl methacrylate (EMA), propyl methacrylate, butyl methacrylate, P-hydroxyethyl methacrylate, dimethylaminoethyl methacrylate, 2-ethylhexylacrylate, isopropyl acetate, vinyl acetate (VA), vinyl propionate, vinyl imidazole (VIM), acrylamide (AAm), diacetone acrylamide (DAAm), allyl chloride, vinyl bromide, vinyl chloride, vinylidene chloride, sodium vinyl sulfonate, sodium p-styrene sulfonate (SSS), sodium methallyl sulfonate (SMS), sodium-2-acrylamido-2-methyl propane sulfonate (SAMPS), and mixtures thereof.

10. The process according to claim 1, wherein polymer B comprises one or more repeating units derived from at least one monomer according to formula (I): 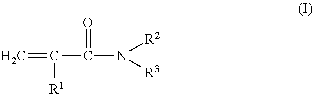
wherein:
R¹ is H or methyl,
R² and R³ are each independently H or alkyl.

11. The process according to claim 10, wherein polymer B is a homopolymer derived from a monomer according to formula (I).

12. The process according to claim 10, wherein polymer B is a copolymer comprising monomeric units derived from a monomer according to formula (I), wherein greater than or equal to about 50 percent by weight (“wt %”) of the repeating units of the polymer are derived from a monomer according to formula (I).

13. The process according to claim 1, wherein polymer B comprises one or more repeating units derived from at least one monomer according to formula (II): 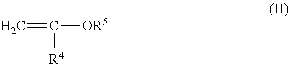
wherein:
R⁴ is H or methyl,
R⁵ is H, alkyl, or acyl, typically H or acyl.

14. The process according to claim 13, wherein polymer B is a homopolymer derived from a monomer according to formula (II).

15. The process according to claim 13, wherein polymer B is a copolymer comprising monomeric units derived from a monomer according to formula (II), wherein greater than or equal to about 50 percent by weight (“wt %”) of the repeating units of the polymer are derived from a monomer according to formula (II).

16. The process according to claim 1, wherein step b) comprises spinning the homogeneous solution formed in step a) in or into a coagulation bath containing the second liquid comprising a solvent for polymer A and a non-solvent for polymer A to form the polyacrylonitrile-based material as one or more fibers.

17. The process according to claim 1, wherein step c) comprises drawing the one or more fibers through one or more draw and wash baths, wherein at least one bath contains the third liquid comprising a non-solvent for polymer A.

18. The process according to claim 1, wherein the second liquid comprises less than or equal to 85 wt % of the solvent for polymer A and greater than or equal to 15 wt % of the non-solvent for polymer A, relative to the total weight of the second liquid.

19. The process according to claim 1, wherein, in step a), the homogeneous solution comprises less than or equal to 50 wt %, relative to the total weight of the homogeneous solution.

20. The process according to claim 1, further comprising a step d) of drying the polyacrylonitrile-based fiber produced in step c).

21. The process according to claim 1, further comprising a step e) of recovering at least partially polymer B.

22. A polyacrylonitrile-based fiber produced by the process according to claim 1.

23. A process for producing carbon fiber, the process comprising:
(i) producing a polyacrylonitrile-based fiber according to the process according to claim 1;
(ii) oxidizing the polyacrylonitrile-based fiber produced in step (i) to form stabilized carbon fiber precursor fibers and then carbonizing the stabilized carbon fiber precursor fiber, thereby producing the carbon fiber.

24. The carbon fiber produced by the process according to claim 23.

25. The carbon fiber according to claim 24, wherein the density is less than or equal to 1.80 g/cm³.

26. The carbon fiber according to claim 24, wherein the density is from 1.50 to 1.77 g/cm³.

27. The carbon fiber according to claim 24, wherein the density is from 1.70 to 1.77 g/cm³ or from 1.74 to 1.79 g/cm³.

28. A composite material comprising the carbon fiber produced according to the process of claim 23 and a matrix resin.

29. A composite article obtained by curing the composite material according to claim 28.
